(19) United States
(12) Patent Application Publication
(10) Pub. No.: US 2026/0249877 A1
(43) Pub. Date: Aug. 27, 2026

(54) VEHICLE

(71) Applicant: KAWASAKI MOTORS, LTD., Hyogo (JP)

(72) Inventors: Shohei TERAI, Hyogo (JP); Takenori SEGAWA, Hyogo (JP)

(73) Assignee: KAWASAKI MOTORS, LTD., Hyogo (JP)

(21) Appl. No.: 19/541,447

(22) Filed: Feb. 17, 2026

Related U.S. Application Data
(60) Provisional application No. 63/761,319, filed on Feb. 21, 2025.

(51) Int. Cl. B60W 60/00; B60W 10/18; B60W 10/20; B60W 30/09; B60W 30/095

(52) U.S. Cl. CPC B60W 60/001; B60W 10/18; B60W 10/20; B60W 30/09; B60W 30/0953

(57) ABSTRACT

A vehicle includes a traveling device and a controller. The vehicle is an off-road vehicle configured to travel over rough terrain. The controller is configured to cause the vehicle to travel autonomously by outputting, to the traveling device, commands according to a travel plan. The controller is configured to acquire a road surface state including at least one of unevenness and an inclination of a road surface, and to decide the travel plan based on the acquired road surface state.

### CROSS-REFERENCE TO RELATED APPLICATION

This application claims the benefit of U.S. Provisional Application No. 63/761,319, filed on Feb. 21, 2025, the entire contents of which are incorporated by reference herein.

### TECHNICAL FIELD

The present disclosure relates to a vehicle.

### BACKGROUND OF THE INVENTION

In JP 2020-013379 A, a vehicle is disclosed that is capable of automatic operation in which the vehicle travels along a predetermined route based on a predetermined operation plan.

### SUMMARY OF THE INVENTION

According to a first aspect of the present disclosure, a vehicle is provided. The vehicle is an off-road vehicle capable of traveling over rough terrain. The vehicle includes a traveling device configured to cause the vehicle to travel, and a controller configured to cause the vehicle to travel autonomously by outputting, to the traveling device, a command according to a travel plan. The controller acquires a road surface state including at least one of unevenness and an inclination of a road surface, and decides the travel plan based on the acquired road surface state.

According to this aspect, it is possible to cause the vehicle to travel using the travel plan suitable for the vehicle traveling off-road.

### BRIEF DESCRIPTION OF DRAWINGS

FIG. 1 is a schematic configuration view of a vehicle.

FIG. 2 is a system configuration view of the vehicle.

FIG. 3 is a flowchart showing an example of travel planning processing.

FIG. 4 is a flowchart showing an example of travel planning executed during travel of the vehicle.

FIG. 5 is a flowchart showing an example of travel planning executed before a start of travel of the vehicle.

FIG. 6 is a flowchart showing an example of processing at step S122.

FIG. 7 is a flowchart showing an example of evaluation value calculation processing in the travel planning.

FIG. 8 is a view for describing an image of the evaluation value calculation processing in uneven road surface travel.

### DETAILED DESCRIPTION OF THE INVENTION

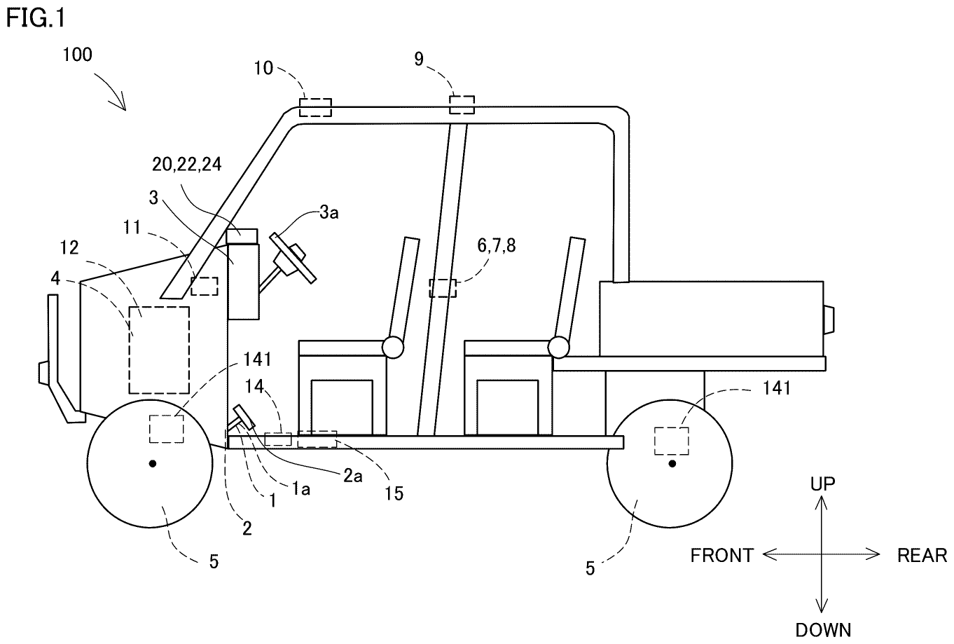

FIG. 1 is a schematic configuration view of a vehicle 100 according to an embodiment of the present disclosure. The vehicle 100 according to the present embodiment is an off-road vehicle that travels on rough terrain. The vehicle 100 is configured to travel on terrain that is not paved, such as earth, mud, rocks and the like in a desert or a forest, for example.

The vehicle 100 includes a rollover protective structure (ROPS) and a cargo bed. The vehicle 100 is a so-called autonomous vehicle that can plan a route from a departure location to a target location, and can travel autonomously along the planned route. The autonomous travel is also referred to as autonomous operation. The vehicle 100 is capable of unmanned autonomous travel in which a driver is not on board, or manned autonomous travel in which the driver is on board. Note that, in the present disclosure, the driver may be appropriately referred to as an occupant.

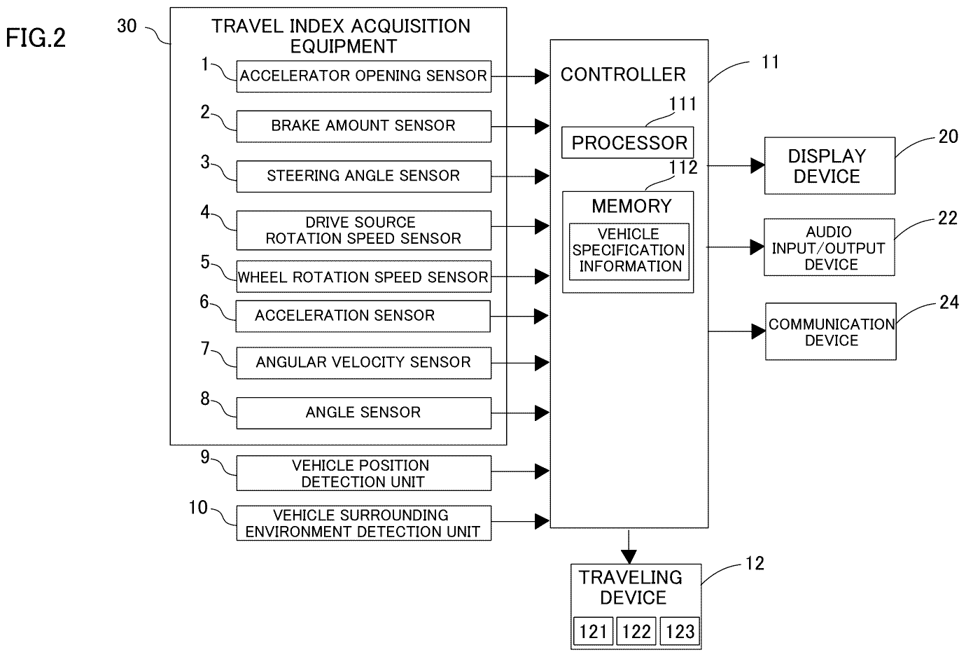

FIG. 2 is a schematic system configuration view of a vehicle. The vehicle 100 mainly includes a traveling device 12, travel index acquisition equipment 30, a vehicle position detection unit 9, a vehicle surrounding environment detection unit 10, a controller 11, a display device 20, an audio input/output device 22, and a communication device 24.

The traveling device 12 includes a drive device 121, a braking device 122, and a steering device 123. The drive device 121 is a device configured to output a drive force to be imparted to the vehicle 100, in order to cause the vehicle 100 to travel. The drive device 121 is, for example, an internal combustion engine, a motor, or the like. The braking device 122 is a device configured to output a braking force to be imparted to the vehicle 100, in order to brake the vehicle 100. The braking device 122 is a brake device, for example. The steering device 123 is a device configured to output a steering force to be imparted to the vehicle 100, in order to steer the vehicle 100. The steering device 123 is a steering mechanism, a steering unit, for example.

The vehicle 100 according to the present embodiment further includes a differential switching device 14, and a drive switching device 15. The differential switching device 14 controls a differential device of the front wheels and a differential device 141 of the rear wheels, and is configured to switch a differential state of the front wheels and the rear wheels between a differential-free state and a differential-lock state. The drive switching device 15 is configured to switch the drive state of the vehicle 100 between a two-wheel drive state in which only the left and right rear wheels are driven, and a four-wheel drive state in which the left and right front wheels and the left and right rear wheels are driven.

Note that, in FIG. 1 and the subsequent drawings, the vehicle 100 is exemplified by a configuration to which reference signs are allocated. Arrangements and sizes of each of the configurations (each of components) in the drawings do not represent actual arrangements and sizes.

As shown in FIG. 1, operation elements (operation devices) for operating the vehicle 100, such as a seat, an accelerator pedal 1a, a brake pedal 2a, a steering wheel 3a, and the like that are equipment for the driver, are installed in the vehicle 100. Note that when the autonomous travel is unmanned, this equipment for the driver need not necessarily be installed in the vehicle 100.

The travel index acquisition equipment 30 (travel-state detection unit) detects information indicating a travel state of the vehicle 100 (behavior of the vehicle 100). As shown in FIG. 2, for example, the travel index acquisition equipment 30 includes an accelerator opening sensor 1, a brake amount sensor 2, a steering angle sensor 3, a drive source rotation speed sensor 4, a wheel rotation speed sensor 5, an acceleration sensor 6, an angular velocity sensor 7, and an angle sensor 8.

The accelerator opening sensor 1 detects an operation amount of the accelerator pedal 1a. The brake amount sensor 2 detects an operation amount of the brake pedal 2a. The steering angle sensor 3 detects an operation direction and an operation amount of the steering wheel 3a. During driving of the vehicle 100 by the driver, outputs from the drive device 121, the braking device 122, and the steering device 123 are performed in accordance with the operation amounts of the accelerator pedal 1a, the brake pedal 2a, the steering wheel 3a.

The drive source rotation speed sensor 4 detects a rotation speed of an output shaft of a drive source. The wheel rotation speed sensor 5 detects a rotation speed of a drive wheel. The wheel rotation speed sensor 5 may detect a rotation speed of a non-driven wheel. The acceleration sensor 6 is an inertial sensor, and detects an external force acting on the vehicle 100. The angular velocity sensor 7 detects a wheel angular velocity. The angle sensor 8 is a gyro sensor, and detects a posture of the vehicle 100. The vehicle 100 may further include various sensors, such as a stroke sensor provided on a suspension or the like. The posture of the vehicle 100 may be estimated from a degree of acceleration obtained by performing an arithmetic operation on an expansion/contraction amount of the stroke sensor provided on the suspension and a detection result of the stroke sensor.

The vehicle position detection unit 9 (the vehicle position detector) is configured to detect the position of the vehicle 100. The position of the vehicle 100 can also be said to be a vehicle position, or a self-position. In the present embodiment, the vehicle position detection unit 9 includes a global navigation satellite system (GNSS). The vehicle position detection unit 9 may output, as the vehicle position, a position obtained by performing an arithmetic operation on detection results of a wheel velocity sensor, an inertial sensor, and the like. In addition to or in place of the GNSS, the vehicle position detection unit 9 may acquire position information of the vehicle 100 from a ground base station, via the communication device 24. The vehicle position may include the travel state indicating information relating to the travel and behavior of the vehicle 100.

The vehicle surrounding environment detection unit 10 is configured to detect a road surface state of an area in front of a planned travel route of the vehicle 100 and of surroundings of the vehicle 100. The road surface state detected by the vehicle surrounding environment detection unit 10 includes information relating to unevenness of the road surface and an inclination of the road surface. The road surface state may also be referred to as road surface information. The unevenness of the road surface may include ups and downs. The inclination of the road surface may be a road surface having a degree of inclination equal to or greater than a predetermined degree of inclination. The road surface state may include information relating to at least one of an obstacle, unevenness of the road surface, muddiness of the road surface, and a road width, in a traveling direction of the vehicle 100. For example, the controller 11 to be described later may acquire the detection results of the vehicle surrounding environment detection unit 10 as the road surface state, or may acquire information calculated by performing arithmetic processing on these detection results, as the road surface state. The vehicle surrounding environment detection unit 10 includes a camera, for example. In addition to the camera, the vehicle surrounding environment detection unit 10 may include a distance sensor that uses radar, laser, infrared, sound waves, or the like.

The vehicle surrounding environment detection unit 10 includes a sensor that is able to detect the unevenness and the inclination of the road surface. Of the unevenness of the road surface, the vehicle surrounding environment detection unit 10 is preferably configured to detect protrusions having a width smaller than a vehicle width of the vehicle 100, and recesses (depressions) having a width smaller than the vehicle width of the vehicle 100. Of the unevenness of the road surface, the protrusion having the width smaller than the vehicle width of the vehicle 100 will also be referred to as a road surface protrusion. Of the unevenness of the road surface, the recess having the width smaller than the vehicle width of the vehicle 100 will also be referred to as a road surface recess. The road surface protrusion may be a fallen tree or a fallen rock, for example. The road surface recess may be a crevice-shaped crack, a ditch, or a rut, for example.

The vehicle surrounding environment detection unit 10 is configured to determine whether or not a height of the road surface protrusion is higher than a ground clearance of the vehicle 100. The ground clearance is a height of a bottom surface of the vehicle 100 from a ground contact surface of the tires of the vehicle 100. The vehicle surrounding environment detection unit 10 is preferably configured to detect a road width of the road surface that can be traveled on. The recognition of the road surface protrusions and the road surface recess in the vehicle surrounding environment detection unit 10 may be realized by a learning arithmetic operation using image processing.

The communication device 24 communicates with the outside of the vehicle 100 via a public network or the like. The communication with the outside of the vehicle 100 includes a management center of the vehicle 100, or a server device provided at a position separated from the vehicle 100. The communication device 24 need not necessarily be installed in the vehicle 100. The communication device 24 may be provided in a mobile device, such as a smartphone or a tablet terminal carried by the driver. The controller 11 may communicate with the outside of the vehicle 100 via the mobile device.

The display device 20 is a display of an instrument panel or a navigation device, for example. The audio input/output device 22 is a microphone and a speaker. The vehicle 100 can perform notification of information, such as the travel state of the vehicle 100, a warning, or the like, via the display device 20 and the audio input/output device 22, or the like. The vehicle 100 is configured to allow the driver to input information relating to route planning, such as the current position, the target location and the like, via the display device 20 and the audio input/output device 22, or the like.

The controller 11 includes a processor 111 and a memory 112. The controller 11 is configured to transmit and receive signals with each of the components of the vehicle 100. The detection results of the travel index acquisition equipment 30, the vehicle position detection unit 9, and the vehicle surrounding environment detection unit 10 are input to the controller 11, for example. The controller 11 outputs various commands (signals), for causing the vehicle 100 to travel autonomously, to the drive device 121, the braking device 122, and the steering device 123 of the traveling device 12, and causes the vehicle 100 to travel autonomously by controlling the drive device 121, the braking device 122, and the steering device 123. The commands output to the traveling device 12 from the controller 11 will also be referred to as travel commands, or autonomous commands. Further, the controller 11 can acquire various information from the display device 20 and the audio input/output device 22, and can output various information to the display device 20 and the audio input/output device 22.

The controller 11 can execute various processing. For example, the controller 11 decides (generates, sets) a travel plan of the vehicle 100. The controller 11 controls the traveling device 12 such that the vehicle 100 travels autonomously in accordance with the decided travel plan. The travel planning includes deciding (setting, planning) the route from a predetermined departure location (current position) to the target location, and the travel state (travel conditions) of the vehicle 100 when traveling on the route. The travel plan and travel planning will also be referred to as a route plan or the route planning.

The controller 11 can accelerate and decelerate the vehicle 100, can steer the vehicle 100, and can execute the switching of the drive state of the vehicle 100, and the like by controlling various units of the vehicle 100. The drive state of the vehicle 100 includes a state of transmitting a drive force to a drive wheel. The drive state includes, for example, a number of the drive wheels (two-wheel drive, four-wheel drive), and engagement/disengagement of the differential lock. The differential lock includes a front wheel lock, and a rear wheel lock. Further, the switching of the drive state includes switching the vehicle 100 between two-wheel drive and four-wheel drive via the drive switching device 15, switching between the differential-free state and the differential-lock state via the differential switching device 14, changing a gear ratio, switching between a forward movement state and a reverse movement state, and the like. The differential-lock state will also be referred to as the differential lock being engaged, and the differential-free state will also be referred to as the differential lock being disengaged.

The controller 11 may decide (generate) the travel plan before the travel of the vehicle 100, may generate the travel plan during the travel of the vehicle 100, or may change the decided travel plan, as needed, during the travel of the vehicle 100. The changing of the travel plan may include traveling a detour route that makes a detour from the departure location to the target location, changing (suppressing) a decided travel speed, or the like.

Vehicle specification information that indicates the vehicle class or performance of the vehicle 100 is stored in advance in the memory 112. The vehicle specification information includes various information relating to the vehicle 100, such as a total length, a total width, a wheel diameter, a wheel base, and a designed minimum turning radius of the vehicle 100, and the like, for example.

Map information may be further stored in the memory 112. The map information may be acquired from outside via the communication device 24. The map information may include information (the road surface state) obtained through the detection by the vehicle surrounding environment detection unit 10. The map information may include a longitude, a latitude, and a road surface height. The map information may be two-dimensional map information, or may be three-dimensional map information. The controller 11 may update the map information based on information and the like provided from one or more vehicles around the vehicle 100, or from an external server, acquired via the communication device 24.

The vehicle specification information that is information indicating the vehicle class or performance of the vehicle 100 is stored in advance in the memory 112. The vehicle specification information includes various information relating to the vehicle 100, such as the total length, the total width, the wheel diameter, a wheel width, a ground clearance, the wheel base, and the designed minimum turning radius of the vehicle 100.

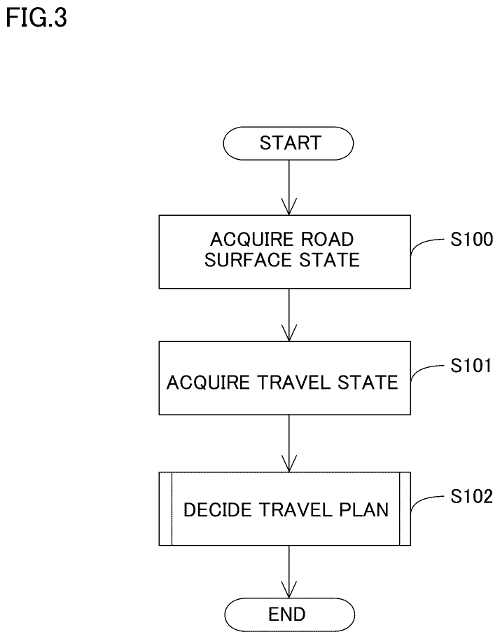

FIG. 3 is a flowchart showing an example of the travel planning processing executed by the processor 111 of the controller 11. For example, at a predetermined interval, the processor 111 of the controller 11 generates (decides) the route plan, which includes a departure position, the route from the current position to the target location, and the travel conditions such as the speed and drive state of the vehicle 100, and causes the vehicle 100 to travel autonomously based on the decided travel plan.

At step S100, the processor 111 acquires information relating to the road surface state via the vehicle surrounding environment detection unit 10. As described above, the road surface state includes the information about the road surface in the surroundings of the vehicle 100, such as the unevenness, ups and downs, the inclination and the like of the road surface in front of (in front of and surrounding) the vehicle 100. Note that, when the map information associated with the position and the road surface state is stored in the memory 112, the processor 111 may refer to the memory 112 and may acquire the road surface state corresponding to the vehicle position detected by the vehicle position detection unit 9.

At step S101, the processor 111 acquires the travel state. As described above, the travel state is the information relating to travel indices of the vehicle 100, and includes at least one of the vehicle position, the vehicle speed, the vehicle posture, and a steering direction. For example, the processor 111 acquires the travel state via the vehicle position detection unit 9 and the vehicle surrounding environment detection unit 10. The vehicle position may be acquired from the vehicle position detection unit 9, or may be estimated based on the travel state of the vehicle 100. The travel state may include a slip state of the vehicle 100.

At step S102, the processor 111 decides the travel plan based on the information acquired at step S100 and step S101. The controller 11 controls the traveling device 12 such that the vehicle 100 travels autonomously in accordance with the plan.

The travel planning at step S102 can be executed before and during the travel of the vehicle 100. First, the travel planning during the travel of the vehicle 100 will be described.

### Travel Planning During Travel

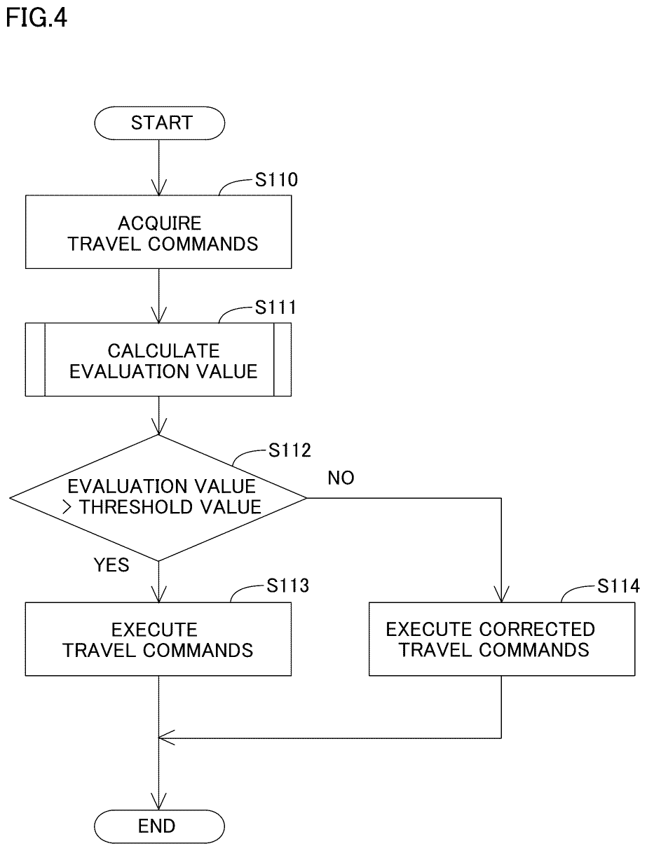

FIG. 4 is a flowchart showing an example of the travel planning executed during the travel of the vehicle 100. This processing is repeatedly executed during the autonomous travel of the vehicle 100 along the route toward the target location.

At step S110, the processor 111 acquires the travel commands. The travel commands acquired at step S110 may be the travel commands output to the traveling device 12 in order to cause the vehicle 100 to travel along the current route. The travel commands to cause the vehicle 100 to travel along the route may be stored in the memory 112 before the travel of the vehicle 100, or at the start of the travel of the vehicle 100. The processor 111 may refer to the memory 112 and acquire the travel commands, or may acquire the travel commands output to the traveling device 12.

At step S111, the processor 111 calculates an evaluation value of the route in front of the vehicle 100. Calculating the evaluation value may be regarded as evaluating a cost; a higher evaluation value corresponds to a lower cost. The higher the evaluation value of the route, namely, the lower the cost of the route, the more the route is suited to the autonomous travel of the vehicle 100. The processor 111 calculates the evaluation value based on the road surface state and the travel state acquired at step S100 and step S101. Evaluation value calculation processing will be described in detail later.

At step S112, the processor 111 determines whether or not the evaluation value calculated at step S111 exceeds a threshold value. The threshold value may be established in advance by experimentation or simulation and may be stored in the memory 112. When the evaluation value exceeds the threshold value (yes at step S112), the processor 111 outputs the travel commands at step S110 to the traveling device 12. In this way, the vehicle 100 travels toward the target location without changing the current route.

When the evaluation value is equal to or lower than the threshold value (no at step S112), the processor 111 advances the processing to step S114, and corrects the travel commands. For example, when, from the road surface state and the travel state, it is understood that the vehicle 100 is traveling so as to traverse an inclined road surface, the processor 111 corrects the travel commands so as to suppress deviation of the steering amount and the steering angle in an uphill direction of the inclined road surface. Further, when the steering amount or the steering angle in the uphill direction are deviating, the processor 111 corrects the travel commands to reduce the vehicle speed. In this way, the vehicle 100 travels along the route corrected from the current route, or travels in the travel state in which the vehicle speed, the steering amount, and the like are suppressed while maintaining the current route.

The following examples can be further given as examples of correction processing at step S114. The following examples can be combined as appropriate.

For example, when the vehicle 100 is caused to travel using the current route and travel commands, a case may be assumed in which an external force that acts on the vehicle 100 and causes angular displacement of a vehicle body around a front-rear direction axis of the vehicle body exceeds a predetermined value established in advance. In this kind of case, the processor 111 may correct the travel commands such that the external force becomes equal to or lower than the predetermined value. The processor 111 may adjust at least one of the steering amount, the vehicle speed, and the turning radius so as to suppress the external force to be equal to or lower than the predetermined value. A centrifugal force, gravity, an inertial force caused by a posture change of the vehicle body when the vehicle wheel comes into contact with the recess or the protrusion, and the like are assumed as the external force. By correcting the travel commands such that the external force becomes equal to or lower than the predetermined value, the vehicle 100 can be caused to travel autonomously in a stable manner.

For example, when the vehicle 100 is caused to travel using the current route and travel commands, in an assumed case in which a change value per unit time of the vehicle posture around the front-rear direction axis of the vehicle body exceeds a predetermined value, the processor 111 may correct the travel commands such that the change value becomes equal to or lower than the predetermined value. For example, the processor 111 may adjust at least one of the steering amount, the vehicle speed, the acceleration, the brake amount, and the turning radius so as to suppress the change value to be equal to or lower than the predetermined value. By correcting the travel commands such that the change value becomes equal to or lower than the predetermined value, the vehicle 100 can be caused to travel autonomously in a stable manner.

For example, the processor 111 may correct the travel commands in accordance with the degree of inclination of the inclined road surface. For example, a degree of correction of the travel commands may be made larger the greater the degree of inclination. For example, when the degree of inclination is greater than a predetermined value, the processor 111 may correct the travel commands such that a centrifugal force acts in a direction pressing the vehicle 100 toward the ground surface.

### Travel Planning Before Start of Travel

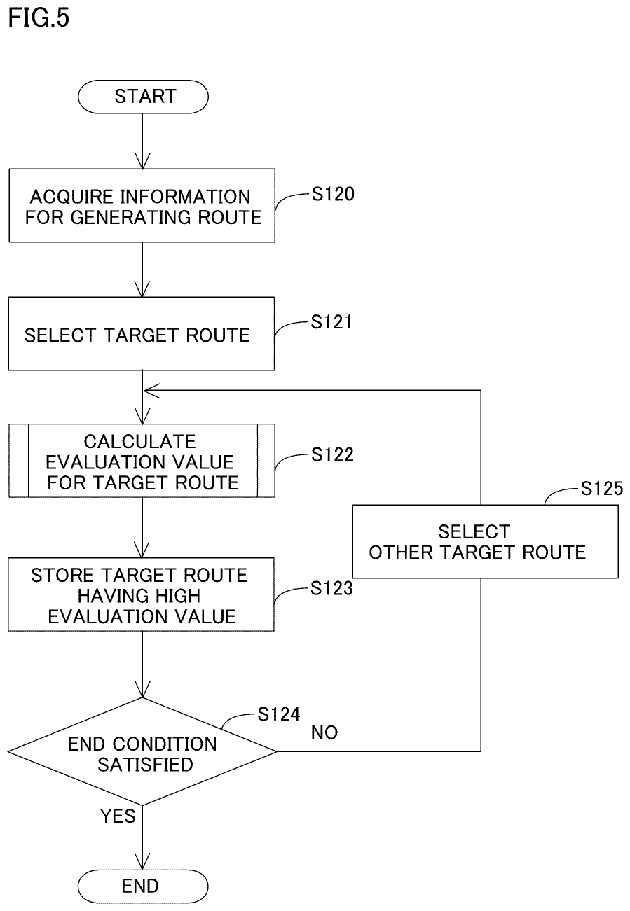

FIG. 5 is a flowchart showing an example of the travel planning executed before the start of travel of the vehicle 100. At step S120, the processor 111 acquires information for route generation. For example, the processor 111 acquires the current position, the departure location, and the target location of the vehicle 100. The processor 111 generates the route linking the departure location and the target location, using predetermined route generation rules. A plurality of the routes can be generated.

At step S121, the processor 111 selects, from a plurality of candidates of the routes linking the departure location and the target location, a specific candidate (candidate route). The selection of the candidate route may be executed by a user. The processor 111 may display the plurality of candidate routes on the display device 20, and may output information prompting the user to make the selection.

At step S122, the processor 111 calculates the evaluation value based on the candidate route selected at step S121. The processor 111 calculates the evaluation value based on the road surface state and the travel state acquired at step S100 and step S101. The processor 111 may acquire the road surface state from an external device or the memory 112. The processor 111 preferably generates three-dimensional map information based on the acquired road surface state, and uses the generated three-dimensional map information. The specific evaluation value calculation processing will be described later.

At step S123, the processor 111 stores the candidate route having the high evaluation value. For example, the processor 111 may store, in the memory 112, the evaluation value calculated at step S122 in association with the candidate route. When the evaluation value and the candidate route are already stored in the memory 112, and the evaluation value calculated at the immediately preceding step S122 is higher than the already stored evaluation value, the processor 111 may overwrite the memory 112.

At step S124, the processor 111 determines whether or not a predetermined end condition has been satisfied. The end condition may include that the evaluation value of the candidate route stored in the memory 112 has exceeded at predetermined upper limit. The end condition may be that step S122 has been executed a predetermined number of times. When the end condition has not been satisfied (no at step S124), at step S125, the processor 111 selects another of the candidates and executes the processing from step S122 to step S124.

When the end condition has been satisfied (yes at step S124), the processor 111 ends the travel planning processing before the start of the travel. The processor 111 can apply, as the route in the travel plan before the start of the travel, the candidate route for which the evaluation (evaluation value) is highest when the end condition is satisfied.

### Dividing of Candidate Route

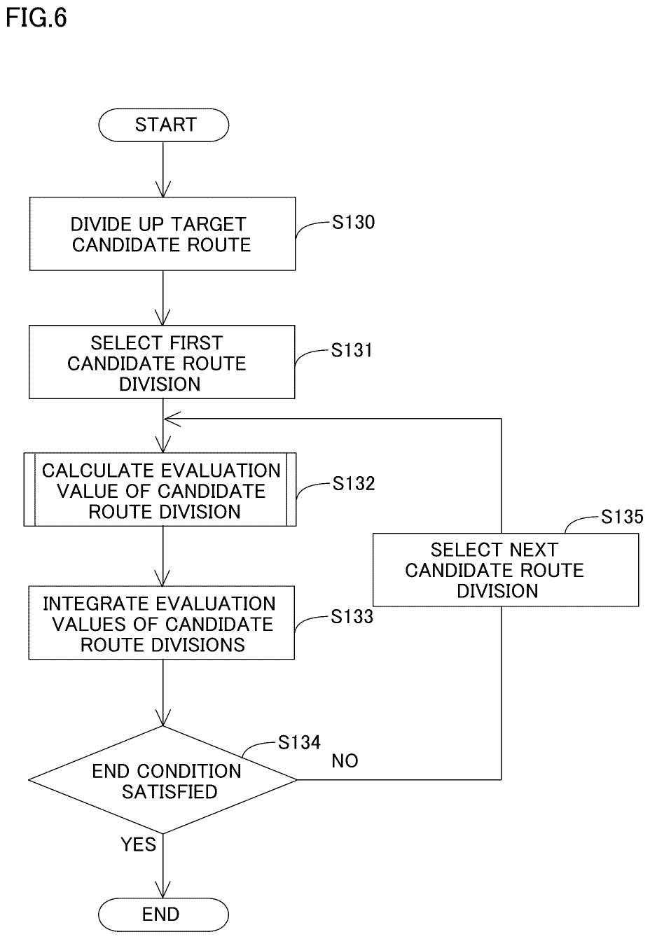

FIG. 6 is an example of the travel planning executed before the start of travel by the vehicle 100, and is a flowchart for describing an example of the processing at step S122. The processing shown in FIG. 6 is processing to divide the candidate route into a plurality of sections, and to calculate the evaluation value for each of the divided candidate route sections. Hereinafter, a single divided candidate route section is also referred to as a candidate route division.

Specifically, at step S130, the processor 111 divides the candidate route (the candidate for the route) selected at step S122 described above, into the plurality of divisions.

At step S131, the processor 111 selects the first candidate route division. The first candidate route division is, for example, the candidate route division closest to the departure location.

At step S132, the processor 111 calculates the evaluation value of the candidate route division selected at step S131. The calculation of the evaluation value will be described later.

At step S133, the processor 111 integrates the evaluation values of the candidate route divisions calculated up to the present time, and stores the integrated evaluation value in the memory 112.

At step S134, the processor 111 determines whether or not a predetermined ending condition is satisfied. The predetermined ending condition may be that the processing at step S132 has been executed for all of the candidate route divisions. When the predetermined ending condition is not satisfied (no at step S134), the processor 111 advances the processing to step S135, selects the next candidate route division, and repeats the processing from step S132 to step S134.

When the predetermined ending condition is satisfied (yes at step S134), the processor 111 returns the processing to the travel planning before the start of the travel shown in FIG. 5, ends the processing at step S122, and advances the processing to step S123.

### Evaluation Value Calculation

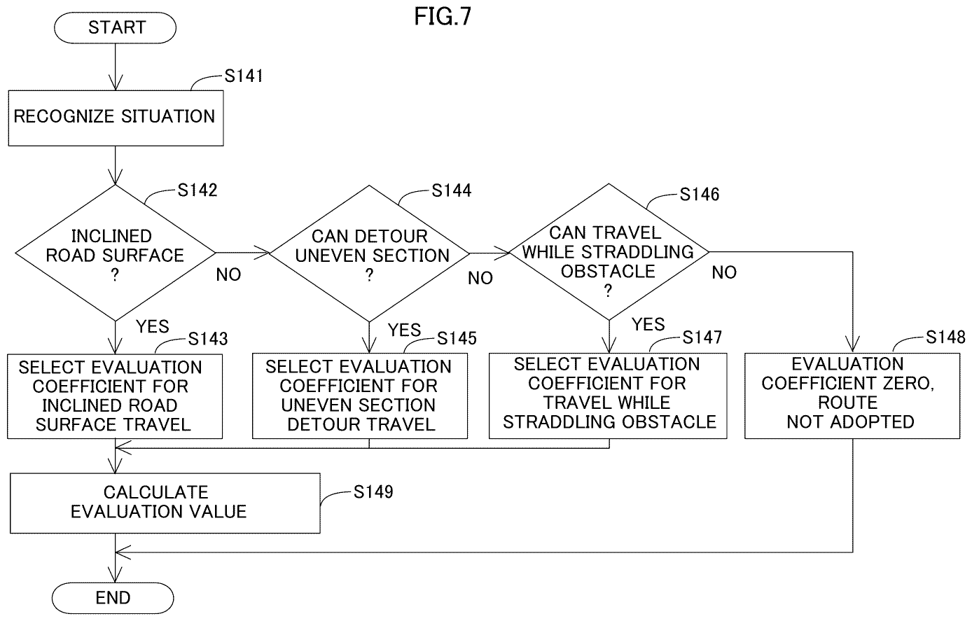

FIG. 7 is a flowchart showing an example of the evaluation value calculation processing in the travel planning. This processing is an example of the processing at step S111 and step S132 in the above-described travel planning processing, for example.

At step S141, the processor 111 recognizes the environment (road surface state) surrounding the vehicle 100. The recognition of the surrounding environment may be recognizing the surrounding road surface state in front of the vehicle 100.

At step S141, the processor 111 acquires and recognizes the road surface state of the vehicle 100. For example, the processor 111 analyzes the road surface state in a predetermined surrounding range in front of the vehicle 100 and performs arithmetic processing to determine whether or not the road surface state is the inclined road surface, and whether or not the road surface is the uneven road surface in which the protrusions and recesses are present in the road surface. For example, when it is the uneven road surface, the processor 111 determines whether or not this corresponds to the above-described road surface recess or road surface protrusion. The processor 111 may perform the processing at step S141 based on the road surface state acquired at step S100 and step S101 described above.

For example, the processor 111 may determine (estimate) whether or not it is the inclined road surface from a camera image, or may calculate the vehicle posture from detection results of a gyro sensor, a GPS (GNSS) sensor, a stroke sensor, or the like and may determine (estimate) whether or not it is the inclined road surface based on the calculated vehicle posture.

When the road surface state is the inclined road surface (yes at step S142), the processor 111 advances the processing to step S143. At step S143, the processor 111 selects an evaluation value (an evaluation coefficient) corresponding to the inclined road surface.

At step S149, the processor 111 calculates the evaluation value based on the selected evaluation coefficient. The processor 111 may take into account the travel state acquired at step S101.

The following can be given as examples of assigning the evaluation value when the road surface state is the inclined road surface. For example, when the travel state is steering in an uphill direction in which the vehicle 100 transitions from travel at which the center of gravity height of the vehicle 100 is maintained (travel traversing the inclined road surface) to travel in which the vehicle center of gravity becomes higher, a lower evaluation value is assigned, compared to when the steering is in a direction different from the uphill direction. For example, when the travel state is steering in which the vehicle 100 transitions from travel at which the center of gravity of the vehicle 100 becomes gradually lower (travel downward on the inclined road surface) to travel in which the center of gravity becomes higher (travel upward on the inclined road surface), the lower evaluation value is assigned, compared to steering in a direction other than the upward direction on the inclined road surface.

The description will return to step S142. When the road surface state is not the inclined road surface (no at step S142), the processor 111 advances the processing to step S144 on the assumption that the target road surface includes an uneven section.

At step S144, the processor 111 determines whether or not the vehicle 100 can detour the uneven section. For example, the processor 111 determines whether or not the vehicle 100 can detour the uneven section based on the acquired road surface state and on the vehicle specification information stored in the memory 112. Specifically, when a width of a section (travel route) other than the uneven section is larger than the vehicle width, the processor 111 determines that the vehicle 100 can detour (yes at step S144), and advances the processing to step S145.

At step S145, the processor 111 selects an evaluation coefficient corresponding to uneven road surface travel that includes the uneven section that can be detoured, and, at step S149, calculates an evaluation value for the route.

For example, since steering is performed when the road surface state is the uneven road surface that can be detoured, the evaluation value in this case may be set to be lower than an evaluation value when traveling straight ahead on a flat route. The evaluation value corresponding to the detour of the uneven road surface may be set to become lower the greater an increase in the steering amount.

Note that, at step S144, when it is the flat road surface in which the uneven section that is the target of the detour is not present, the processor 111 may select an evaluation coefficient corresponding to the flat road surface and advance the processing to step S149.

The description will return to step S144. When it is not the uneven road surface including the uneven section that can be detoured (no at step S144), the processor 111 advances the processing to step S146, and determines whether or not the uneven section is the road surface recess or the road surface protrusion. As described above, the road surface recess is the recess having the width smaller than the vehicle width of the vehicle 100.

When the recess or the protrusion included in the uneven road surface is the road surface recess or the road surface protrusion, the vehicle 100 can perform travel while straddling an obstacle, which is travel while straddling the recess or the protrusion. The travel while straddling the obstacle is travel in which a front left wheel and a rear left wheel are disposed on one side of the recess or the protrusion, and a front right wheel and a rear right wheel are disposed on the other side of the recess or the protrusion. In this type of case, the processor 111 makes the positive determination at step S146 and advances the processing to step S147.

At step S147, the processor 111 selects an evaluation coefficient corresponding to the travel while straddling the recess or the protrusion, and, at step S149, calculates the evaluation value corresponding to the route.

For example, the evaluation value corresponding to the travel while straddling the obstacle may be set to be lower than the evaluation value when traveling straight ahead on the flat route. The evaluation value corresponding to the travel while straddling the obstacle may be set to become lower the greater the increase in the steering amount.

Returning to step S146, when the travel while straddling the obstacle is not possible (no at step S146), the processor 111 advances the processing to step S148, and sets the evaluation value to zero. In this case, the processor 111 may cause the vehicle 100 to reverse in a predetermined direction, and may once more execute the travel planning processing from step S100.

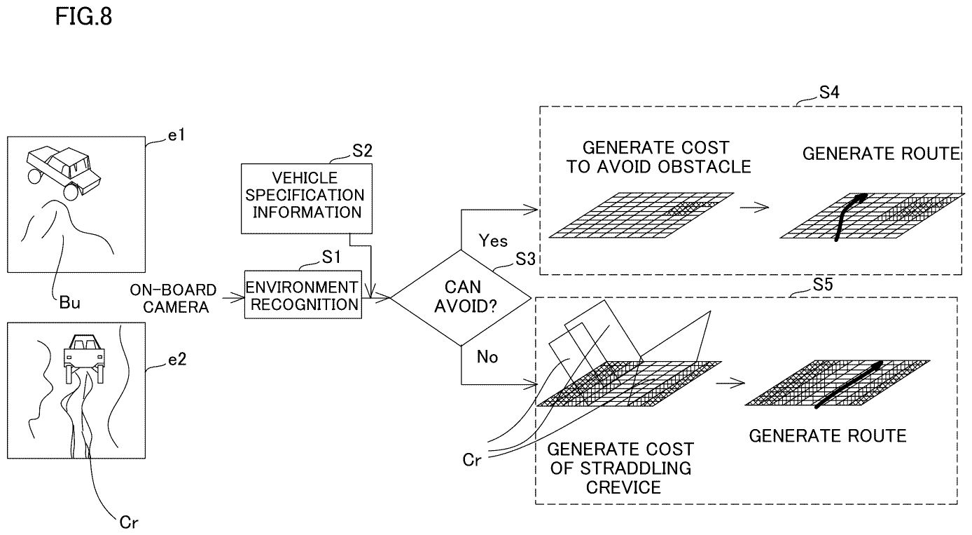

FIG. 8 is a view for describing an image of the evaluation value calculation processing in the uneven road surface travel. In a situation example e1 shown in FIG. 8, a protrusion Bu is present in front of the vehicle 100. In a situation example e2, the protrusion Bu and a recess Cr are present in the surroundings in front of the vehicle 100. The recess Cr is a crevice-shaped crack. For example, the processor 111 acquires the road surface state, as described above, via the vehicle surrounding environment detection unit 10 (step S1). Further, the processor 111 refers to the vehicle specification information stored in the memory 112 (step S2). When, based on the vehicle specification information of the vehicle 100, the road surface state, and the like, the processor 111 further determines that the vehicle 100 can avoid the protrusion Bu (yes at step S3), the cost of avoiding the protrusion Bu, which is the obstacle, is generated, and the route detouring the protrusion Bu is generated (step S4).

Further, for example, when the road surface state includes the uneven road surface shown in the situation example e2, and there is the crevice-shaped recess Cr, when the processor 111 determines, from the travel state of the vehicle 100, the vehicle specification information, and the road surface state, that the vehicle 100 cannot avoid the recess Cr (no at step S3), the processor 111 generates the cost of straddling the recess Cr and generates a straddling route of the recess Cr (step S5). Specifically, the processor 111 sets the evaluation value for the route such that the cost of moving while the wheels pass the recess Cr on the left and right sides becomes lower, in other words, such that the evaluation value becomes higher. In this way, it is possible to suppress the setting of a route in which the wheels come into contact with the uneven section.

As described above, it is assumed that, in contrast to a vehicle that travels on a paved road, the vehicle 100 that travels off-road travels over a road surface that is an inclined road surface, an uneven road surface, or a road surface that includes crevice-shaped cracks. In the present embodiment, in the travel planning, the evaluation value is assigned in accordance with the road surface state, and the route having the higher evaluation value is applied as the route over which the vehicle 100 is caused to travel. Thus, it is possible to cause the vehicle 100 to travel using the travel plan that takes into account the road surface state.

In the above-described travel planning, for example, the travel planning is executed using the methods described below.
(a) With respect to the inclined road surface, the cost relating to the route in which the steering in the uphill direction is performed is set to be higher.
(b) With respect to the uneven road surface having the uneven section that can be detoured, the cost relating to the route that avoids the uneven section is set to be lower.
(b1) In (b) described above, of the routes for avoiding the uneven section, the cost is set to be lower the smaller the steering amount on the route.
(c) With respect to the uneven road surface having at least one of the road surface recess and the road surface protrusion, the cost relating to the route in which the travel is executed while straddling the road surface recess and the road surface protrusion is set to be lower.
(c1) In (c) described above, of the routes on which the travel while straddling the obstacle is executed, the cost is set to be lower the smaller the steering amount on the route.

According to the technology of the present disclosure, since the travel planning is executed as described in (a) to (c1), stable autonomous travel is possible even with the road surface state or travel state specific to the off-road travel.

Note that the order of the processing of the travel planning described above, items of the processing, or the various configurations included in the vehicle 100 can be modified as appropriate.

For example, in the above-described travel planning, the assignment of the evaluation value relating to the inclined road surface, the assignment of the evaluation value relating to the detour of the uneven road surface, and the assignment of the evaluation value relating to road surface recess and the road surface protrusion are independently executed, but a comprehensive evaluation value may be assigned to the road surface state that is targeted.

In addition to the evaluation value relating to the road surface state, evaluation values that take into account the vehicle speed, the steering amount, changes in the steering amount over time, the turning radius, the acceleration, the braking amount, and the like may be set and assigned.

For example, when travel is being performed while a ground contact position height of at least one of the wheels is different from the ground contact position height of the other wheels, a lower evaluation value may be set compared to travel while the ground contact position heights are the same. In this way, travel is suppressed on a route on which it is possible for the wheels to become stuck, or on a route on which it is possible that the wheels may slip.

In addition to the evaluation value relating to the road surface state, an evaluation value relating to movement may be assigned. The evaluation value relating to the movement may be, for example, an evaluation value relating to at least one of a movement distance, a movement time, fuel consumption, and an average vehicle speed. The evaluation value relating to the movement may be set to be higher the lower a movement cost.

In addition to the evaluation value relating to the road surface state, an evaluation value relating to changes in the center of gravity of the vehicle 100 may be assigned. The evaluation value relating to the changes in the center of gravity may be an evaluation value relating to at least one of vibrations in the up-down direction, an amplitude of vibration, an acceleration of vibrations, and a posture change amount of the vehicle 100. The evaluation value relating to the changes in the center of gravity may be set to be higher the smaller the change in the center of gravity.

The evaluation value may be set such that the route is not selected on which, of the four wheels, the ground contact position of at least one of the wheels is different from the ground contact position of the other wheels.

The evaluation value may be set such that the route is not selected on which at least one of the wheels passes over the road surface recess or the road surface protrusion.

The processor 111 may be configured to estimate the road surface state based on information detected by the vehicle 100 in the past or detected in other vehicles different from the vehicle 100.

In the travel planning, when the route is decided on which, of the four wheels of the vehicle 100, the ground contact position height of at least one of the wheels is different from the ground contact position height of the other wheels, the processor 111 may set the travel condition of the vehicle 100 so as to increase the traction of the vehicle 100. For example, when the vehicle 100 is in two-wheel drive, the processor 111 may switch the vehicle 100 from the two-wheel drive to four-wheel drive via the drive switching device 15. Further, the processor 111 may switch the differential state of the vehicle 100 from the differential-free state to the differential-lock state.

In the travel planning, when the route is decided on which, of the four wheels of the vehicle 100, the ground contact position height of at least one of the wheels is different from the ground contact position height of the other wheels, the processor 111 may set the travel condition so as to suppress rapid changes in the drive or the braking force.

At least some of the travel planning processing may be executed by another device different from the controller 11, or an external server.

Some of the functions of the vehicle surrounding environment detection unit 10 may be executed by the controller 11. For example, the determination of the road surface recess, the road surface protrusion, and the inclined road surface may be executed by the controller 11 based on the detection results of the sensors, such as the camera and the like, included in the vehicle surrounding environment detection unit 10.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality. There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer readable storage medium, a computer program product, a memory device, a record medium such as a CD-ROM or DVD, and/or the memory of a FPGAs or ASICs.

The present disclosure is not limited to the above-described embodiment and modified examples, and can be realized by various other aspects insofar as these do not depart from the gist and scope thereof. For example, the present disclosure can be realized by the following aspects. Each of technical features in the above-described embodiment and modified examples corresponding to technical features of each of the aspects described below can be switched or combined, as appropriate, in order to solve some or all of the issues of the present disclosure, or to achieve some or all of the effects of the present disclosure. Further, insofar as these technical features are not described as essential in the present specification, they may be omitted as appropriate.
<1> According to a first aspect of the present disclosure, a vehicle is provided. The vehicle is an off-road vehicle configured to travel over rough terrain. The vehicle includes a traveling device configured to cause the vehicle to travel, and a controller configured to cause the vehicle to travel autonomously by outputting, to the traveling device, a command according to a travel plan. The controller is configured to acquire a road surface state including at least one of unevenness and an inclination of a road surface, and to decide the travel plan based on the acquired road surface state.

According to this aspect, since the travel plan is decided based on the road surface state, even when off-road, the vehicle can be caused to travel autonomously in a stable manner.

In this aspect, the road surface state may be a state of the road surface in a region in front of the vehicle, in the surroundings in front of the vehicle. The road surface state may be the road surface state in front of the vehicle on a current planned travel route of the vehicle.

In this aspect, the vehicle may include a detection unit configured to detect the road surface state. The detection unit may include a vehicle surrounding environment detection unit, which is provided in the vehicle and includes at least one sensor configured to detect a situation surrounding the vehicle. The detection unit may include a travel index acquisition equipment, which is provided in the vehicle and includes at least one sensor configured to detect a travel situation of the vehicle.

The at least one sensor may be at least one of a monocular camera, a stereo camera, a LiDAR sensor, a radar sensor, or an infrared sensor.

The at least one sensor may be at least one of a gyro sensor, an inertial sensor, a suspension stroke sensor, an acceleration sensor provided under a suspension spring, or a wheel rotation speed sensor.

The road surface state may include an inclined road surface including an inclined surface, and an uneven road surface including at least one of a recess and a protrusion.

The travel plan may include the route, and travel conditions of the vehicle on the route. The travel conditions may include various travel conditions (modes, states) for causing the vehicle to travel, such as a vehicle speed, an acceleration, a steering operation, a posture, and the like.
<2> In the above-described aspect, the controller may decide the travel plan to cause an external force acting on the vehicle and causing angular displacement of a vehicle body around a front-rear direction axis of the vehicle body to be equal to or lower than a predetermined value.

According to this aspect, it is possible to cause the external force acting on the vehicle due to the unevenness or inclination of the road surface to be equal to or lower than the predetermined value. Thus, even when off-road, the vehicle can be caused to travel autonomously in a stable manner.

The angular displacement around the front-rear direction axis of the vehicle body can be said to be a roll angular displacement of the vehicle body. The external force may be a centrifugal force acting on the vehicle, may be gravity acting on the vehicle on the inclined road surface, may be an inertial force when the posture of the vehicle changes, or may be a combination of these forces.
<3> In the above-described aspect, the controller may decide the travel plan to cause a posture change of a vehicle body around a front-rear direction axis of the vehicle to be equal to or lower than a predetermined value.

According to this aspect, it is possible to cause the posture change of the vehicle body due to the unevenness or inclination of the road surface to be equal to or lower than the predetermined value. Thus, even when off-road, the vehicle can be caused to travel autonomously in a stable manner.

In this aspect, the posture change may be a change amount with respect to a posture when traveling on a paved flat road surface, or may be an extent of the posture change over an elapsed time period.
<4> In the above-described aspect, the controller may further acquire a steering change of the vehicle and a vehicle speed being a travel speed of the vehicle, and may decide the travel plan based on the acquired steering change and vehicle speed.

According to this aspect, it is possible to suppress the travel of the vehicle from becoming unstable due to the road surface state and the steering of the vehicle.

In this aspect, the steering change may include at least one of a steering amount with respect to straight-running of the vehicle, a steering speed, a steering angle, and a steering angular velocity.

The vehicle may include a travel index acquisition equipment configured to acquire information relating to the travel state of the vehicle. The travel index acquisition equipment may include at least one of an accelerator opening sensor, a brake amount sensor, a steering angle sensor, a drive source rotation speed sensor, a wheel rotation speed sensor, an acceleration sensor, an angular velocity sensor, and an angle sensor.
<5> In the above-described aspect, the controller may acquire three-dimensional map information based on the road surface state, and may decide the travel plan based on the acquired three-dimensional map information.

According to this aspect, it is possible to decide a travel plan that takes into account the road surface state of the whole route.

In this aspect, the three-dimensional map information may be generated based on road surface information acquired in the past by the vehicle or by another vehicle different from the vehicle.

In this aspect, the three-dimensional map information may include information including at least one of a prohibited area, a recommended travel route, and a past movement route.
<6> In the above-described aspect, in the travel plan, the controller may assign an evaluation value to a candidate route, the evaluation value being based on predetermined evaluation rules, and may decide a route on which to cause the vehicle to travel based on the evaluation value. The controller may assign a lower evaluation value to a route on which the vehicle travels in a state where a ground contact position height of at least one of a plurality of wheels included in the vehicle is different from a ground contact position height of the other wheels, than to a route on which the vehicle travels in a state where a ground contact position of the plurality of wheels is the same.

According to this aspect, it is possible to plan a route in which travel over an uneven section is suppressed.
<7> In the above-described aspect, in the travel plan, the controller may assign an evaluation value to a candidate route, the evaluation value being based on predetermined evaluation rules, and may decide a route along which to cause the vehicle to travel based on the evaluation value. The evaluation value based on the evaluation rules may include an evaluation value based on the road surface state, and an evaluation value based on at least one of a movement distance, a movement time, and a fuel consumption of the vehicle.

According to this aspect, it is possible to decide the travel plan that takes into account information relating to the movement of the vehicle in addition to the road surface state including at least one of the unevenness and the inclination of the road surface.
<8> In the above-described aspect, the vehicle may include at least one sensor configured to detect a surrounding environment of the vehicle. The controller may acquire the road surface state based on a detection result of the at least one sensor.

According to this aspect, it is possible to decide the travel plan based on the actual road surface state on which the vehicle is to travel.

The at least one sensor may be a sensor included in the vehicle surrounding environment detection unit.
<9> In the above-described aspect, the vehicle may include at least one sensor configured to detect a surrounding environment of the vehicle. The controller may include a memory configured to store information detected in the past by the at least one sensor. In the travel plan, the controller may acquire the road surface state based on the information stored in the memory.

According to this aspect, the travel plan can be decided in advance.
<10> In the above-described aspect, in the travel plan, the controller may decide a route that avoids causing the vehicle to travel in a state where a ground contact position height of at least one of a plurality of wheels included in the vehicle is different from a ground contact position height of the other wheels.

According to this aspect, it is possible to cause the vehicle to travel in a stable manner.
<11> In the above-described aspect, in the travel plan, the controller may decide a route that avoids causing the vehicle to travel in a state where a ground contact position height of a front left wheel and a rear left wheel is different from a ground contact position height of a front right wheel and a rear right wheel.

According to this aspect, it is possible to cause the vehicle to travel in a stable manner.
<12> In the above-described aspect, the vehicle may include travel index acquisition equipment configured to acquire a travel state including a posture of the vehicle. When the road surface state is an inclined road surface and the travel state of the vehicle indicates travel traversing the inclined road surface, compared to a case in which the road surface state is not the inclined road surface, the controller may decide the travel plan to execute at least one of the following (i) and (ii). (i) suppressing a steering operation in an uphill direction. (ii) suppressing at least one of a speed and an acceleration of the vehicle before the steering in the uphill direction is performed.

According to this aspect, it is possible to cause the vehicle to travel in a stable manner.

In this aspect, the steering operation in the uphill direction may be an operation to change at least one of a steering amount, a steering speed, and a steering angular velocity.
<13> In the above-described aspect, the greater an inclination amount of the road surface state, the more the controller may increase an extent of the suppressing.

According to this aspect, since the steering operation or the vehicle speed and the acceleration are suppressed to a greater extent the greater a degree of inclination, it is possible to cause the vehicle to travel in a stable manner even on the inclined road surface.
<14> In the above-described aspect, the controller may include a memory configured to store vehicle specification information. When the road surface state is an uneven road surface including an uneven section, and a width of the uneven section is smaller than a vehicle width included in the vehicle specification information and is larger than the wheel width, the controller may decide a route that avoids traversing the uneven section.

According to this aspect, it is possible to suppress the wheels from becoming stuck.
<15> In the above-described aspect, the controller may include a memory configured to store vehicle specification information. When the road surface state is an uneven road surface including an uneven section, a width of the uneven section is smaller than a vehicle width included in the vehicle specification information, and a height position of the uneven section is less than a ground clearance of a vehicle body, the controller may decide a route on which a front left wheel and a rear left wheel of the vehicle are disposed on one side of the uneven section, and a front right wheel and a rear right wheel are disposed on the other side of the uneven section.

According to this aspect, it is possible to suppress the wheels from becoming stuck. Further, it is possible to decide the travel plan appropriate to off-road travel.

In this aspect, the controller may set an evaluation value to be high for the route on which the front left wheel and the rear left wheel of the vehicle are disposed on one side of the uneven section, and the front right wheel and the rear right wheel are disposed on the other side of the uneven section. The evaluation value for the route may be an evaluation value that is substantially the same as that for a flat road surface.

According to this aspect, the controller may decide the route on which a center in the width direction of the uneven section and a center in the width direction of the vehicle are caused to be aligned.

According to this aspect, a recess in the uneven section may be a recess hollowed downward from the road surface. The recess may be a crevice-shaped crack. A protrusion in the uneven section may be a protrusion protruding upward from the road surface.
<16> In the above-described aspect, the uneven section may include a road surface recess hollowed downward from the road surface.

According to this aspect, it is possible to cause the vehicle to travel along a crevice-shaped crack while straddling the crevice-shaped crack.
<17> In the above-described aspect, the uneven section may include a road surface protrusion protruding upward from the road surface.

According to this aspect, it is possible to cause the vehicle to travel along the protrusion while straddling the protrusion that is lower than a bottom surface of the vehicle body.
<18> In the above-described aspect, the vehicle may include a switching device configured to switch between two-wheel drive and four-wheel drive, and between engagement/disengagement of a differential lock. When it is a travel state in which a ground contact position height of at least one of a plurality of wheels included in the vehicle is different from a ground contact position height of the other wheels, the controller may control the switching device and execute at least one of switching a drive state of the vehicle to the four-wheel drive and switching a differential state of the vehicle to a differential-lock state.

According to this aspect, it is possible to cause the vehicle to travel in a stable manner.
<19> In the above-described aspect, in the travel plan, when the acquired road surface state is the inclined road surface, and a current travel state of the vehicle is a travel state of traversing the inclined road surface, the controller may set a route in a direction different from an uphill direction of the inclined road surface.

According to this aspect, it is possible to enhance the stability of the travel of the vehicle on the inclined road surface.
<20> In the above-described aspect, in the travel plan, when the acquired road surface state includes an uneven section and the uneven section is detourable (i.e., a detour route around the uneven section is available), the controller may decide a route to travel while detouring the uneven section. When the uneven section is not detourable (i.e., no detour route is available), and the road surface state includes a road surface recess present in front of the vehicle, the road surface recess being hollowed downward from the road surface, the controller may decide a route on which a front left wheel and a rear left wheel of the vehicle are disposed to the left of the road surface recess, and a front right wheel and a rear right wheel of the vehicle are disposed to the right of the road surface recess, and may cause the vehicle to travel while straddling the road surface recess. When the uneven section is not detourable (i.e., no detour route is available), and the road surface state includes a road surface protrusion present in front of the vehicle, the road surface protrusion protruding upward from the road surface and being lower than a ground clearance of the vehicle, the controller may decide a route on which the front left wheel and the rear left wheel of the vehicle are disposed to the left of the road surface protrusion, and the front right wheel and the rear right wheel of the vehicle are disposed to the right of the road surface protrusion, and may cause the vehicle to travel while straddling the road surface protrusion.

According to this aspect, it is possible to enhance the stability of the travel of the vehicle even on the uneven road surface.

What is claimed is:

1. A vehicle comprising:
a traveling device configured to cause the vehicle to travel; and
a controller configured to cause the vehicle to travel autonomously by outputting, to the traveling device, a command according to a travel plan, wherein
the vehicle is an off-road vehicle configured to travel over rough terrain, and
the controller acquires a road surface state including at least one of unevenness and an inclination of a road surface, and decides the travel plan based on the acquired road surface state.

2. The vehicle according to claim 1, wherein
the controller decides the travel plan to cause an external force acting on the vehicle and causing angular displacement of a vehicle body around a front-rear direction axis of the vehicle body to be equal to or lower than a predetermined value.

3. The vehicle according to claim 1, wherein
the controller decides the travel plan to cause a posture change of a vehicle body around a front-rear direction axis of the vehicle to be equal to or lower than a predetermined value.

4. The vehicle according to claim 1, wherein
the controller further acquires a steering change of the vehicle and a vehicle speed being a travel speed of the vehicle, and decides the travel plan based on the acquired steering change and vehicle speed.

5. The vehicle according to claim 1, wherein
the controller acquires three-dimensional map information based on the road surface state, and decides the travel plan based on the acquired three-dimensional map information.

6. The vehicle according to claim 1, wherein
in the travel plan, the controller
assigns an evaluation value to a candidate route, the evaluation value being based on predetermined evaluation rules, and decides a route on which to cause the vehicle to travel based on the evaluation value, and
assigns a lower evaluation value to a route on which the vehicle travels in a state where a ground contact position height of at least one of a plurality of wheels included in the vehicle is different from a ground contact position height of the other wheels, than to a route on which the vehicle travels in a state where a ground contact position of the plurality of wheels is the same.

7. The vehicle according to claim 1, wherein
in the travel plan, the controller
assigns an evaluation value to a candidate route, the evaluation value being based on predetermined evaluation rules, and decides a route on which to cause the vehicle to travel based on the evaluation value, and
the evaluation value based on the evaluation rules includes an evaluation value based on the road surface state, and an evaluation value based on at least one of a movement distance, a movement time, and a fuel consumption of the vehicle.

8. The vehicle according to claim 1, comprising:
at least one sensor configured to detect a surrounding environment of the vehicle, wherein
the controller acquires the road surface state based on a detection result of the at least one sensor.

9. The vehicle according to claim 1, comprising:
at least one sensor configured to detect a surrounding environment of the vehicle, wherein
the controller includes a memory configured to store information detected in the past by the at least one sensor, and
in the travel plan, the controller acquires the road surface state based on the information stored in the memory.

10. The vehicle according to claim 1, wherein
in the travel plan, the controller decides a route that avoids causing the vehicle to travel in a state where a ground contact position height of at least one of a plurality of wheels included in the vehicle is different from a ground contact position height of the other wheels.

11. The vehicle according to claim 1, wherein
in the travel plan, the controller decides a route that avoids causing the vehicle to travel in a state where a ground contact position height of a front left wheel and a rear left wheel is different from a ground contact position height of a front right wheel and a rear right wheel.

12. The vehicle according to claim 1, further comprising:
travel index acquisition equipment configured to acquire a travel state including a posture of the vehicle, wherein
when the road surface state is an inclined road surface and the travel state of the vehicle indicates travel traversing the inclined road surface, compared to a case in which the road surface state is not the inclined road surface, the controller decides the travel plan to execute at least one of suppressing a steering operation in an uphill direction, and suppressing at least one of a speed and an acceleration of the vehicle before the steering in the uphill direction is performed.

13. The vehicle according to claim 12, wherein
the greater an inclination amount of the road surface state, the more the controller increases an extent of the suppressing.

14. The vehicle according to claim 1, wherein
the controller includes a memory configured to store vehicle specification information, and
when the road surface state is an uneven road surface including an uneven section, and a width of the uneven section is smaller than a vehicle width included in the vehicle specification information and is larger than a wheel width, the controller decides a route that avoids traversing the uneven section.

15. The vehicle according to claim 1, wherein
the controller includes a memory configured to store vehicle specification information, and
when the road surface state is an uneven road surface including an uneven section, width of the uneven section is smaller than a vehicle width included in the vehicle specification information, and a position in the height direction of the uneven section is less than a ground clearance of a vehicle body, the controller decides a route on which a front left wheel and a rear left wheel of the vehicle are disposed on one side of the uneven section, and a front right wheel and a rear right wheel are disposed on the other side of the uneven section.

16. The vehicle according to claim 15, wherein
the uneven section includes a road surface recess hollowed downward from the road surface, and having a crack shape formed in the road surface.

17. The vehicle according to claim 15, wherein
the uneven section includes a road surface protrusion protruding upward from the road surface.

18. The vehicle according to claim 1, comprising:
a switching device configured to switch between two-wheel drive and four-wheel drive, and between engagement/disengagement of a differential lock, wherein
when the travel state is a state in which a ground contact position height of at least one of a plurality of wheels included in the vehicle is different from a ground contact position height of the other wheels, the controller controls the switching device and executes at least one of switching a drive state of the vehicle to the four-wheel drive and switching a differential state of the vehicle to a differential-lock state.

19. The vehicle according to claim 1, wherein
in the travel plan, when the acquired road surface state is the inclined road surface, and a current travel state of the vehicle is a travel state of traversing the inclined road surface, the controller sets a route in a direction different from an uphill direction of the inclined road surface.

20. The vehicle according to claim 1, wherein
in the travel plan, when the acquired road surface state includes an uneven section and the uneven section is detourable, the controller decides a route to travel while detouring the uneven section,
when the uneven section is not detourable, and the road surface state includes a road surface recess present in front of the vehicle, the road surface recess being hollowed downward from the road surface, the controller decides a route on which a front left wheel and a rear left wheel of the vehicle are disposed to the left of the road surface recess, and a front right wheel and a rear right wheel of the vehicle are disposed to the right of the road surface recess, and causes the vehicle to travel while straddling the road surface recess, and
when the uneven section is not detourable, and the road surface state includes a road surface protrusion present in front of the vehicle, the road surface protrusion protruding upward from the road surface and being lower than a ground clearance of the vehicle, the controller decides a route on which the front left wheel and the rear left wheel of the vehicle are disposed to the left of the road surface protrusion, and the front right wheel and the rear right wheel of the vehicle are disposed to the right of the road surface protrusion, and causes the vehicle to travel while straddling the road surface protrusion.
